(19) United States
(12) Patent Application Publication
(10) Pub. No.: US 2014/0145542 A1
(43) Pub. Date: May 29, 2014

(54) Electric Actuator

(71) Applicant: Hitachi Automotive Systems, Ltd., Hitachinaka-shi (JP)

(72) Inventors: Hiroshi KANAZAWA, Hitachinaka (JP); Hirotaka TAKIMOTO, Hitachinaka (JP); Koichi KASHIWA, Hitachinaka (JP); Masahiro HOSOYA, Hitachinaka (JP); Yasunaga HAMADA, Hitachinaka (JP); Shozo KAWASAKI, Hitachinaka (JP); Kenji NAKAYAMA, Hitachinaka (JP)

(73) Assignee: Hitachi Automotive Systems, Ltd., Hitachinaka-shi (JP)

(21) Appl. No.: 14/080,201

(22) Filed: Nov. 14, 2013

(30) Foreign Application Priority Data
Nov. 29, 2012 (JP) 2012-260465

(51) Int. Cl. H02K 1/18; H02K 3/28

(52) U.S. Cl. CPC H02K 1/185; H02K 3/28
USPC 310/203; 310/216.048

(57) ABSTRACT

In an electrical actuator having a motor in which a plurality of teeth including a continuous winding are formed into a stator core of a ring shape, one wire being continuously wound around the teeth adjacent to each other in the continuous winding, the stator core is configured that step sections of an uneven shape in the axial direction are arranged in butting sections between the teeth connected by the continuous winding, and the uneven shapes are fitted to each other.

### BACKGROUND

The present invention relates to a structure of a stator core section used for a motor.

As a related art of the present technical field, there is Japanese Unexamined Patent Application Publication No. Hei8(1996)-205434. In this publication, one in which fitting sections are formed in butting surfaces of a split core in a same shape in the axial direction is disclosed. Also, there is Japanese Unexamined Patent. Application Publication No. 2011-87374. In this publication, a structure related to connecting sections of a split core is disclosed, the teeth are configured to have same right and left shapes, and uneven sections for connection are arranged in the teeth of one side. Also, in Japanese Patent No. 3005293, one in which sections for fastening teeth of a split core with each other are formed into a hook shape is disclosed. Further, in Japanese Unexamined Patent Application Publication No. 2008-113529, one is disclosed in which butting surfaces of a split core are configured so as to be capable of being fitted to each other with the recesses and the projections alternately to the right and left with respect to the axial direction. Furthermore, in WO2007/086312, a structure is disclosed in which split core fitting sections are arranged in a same shape in the axial direction as described in Japanese Unexamined Patent Application Publication No. Hei8(1996)-205434, and a skew section is arranged at the distal end section of the teeth. The structure for connecting the teeth of these split cores with each other relates to a structure on one piece basis of the tooth.

On the other hand, the motors formed of integer multiples of 8 poles-9 slots, 10 poles-12 slots, 14 poles-12 slots, 20 poles-18 slots, 14 poles-15 slots, and 16 poles-15 slots in which coils of a same phase are disposed continuously have a peculiar structure formed of continuous windings in which same phase windings adjacent to each other are continuously wound around teeth adjacent to each other.

### SUMMARY

A motor in which the same phase windings adjacent to each other are formed of the continuous windings has a problem that the teeth are shifted from each other in the axial direction between the teeth forming the continuous winding and adjacent to each other by strutting of the wire (bridge line) that straddles over the teeth adjacent to each other.

According to the present invention, plural uneven sections are arranged in the axial direction in core butting sections of a portion where the bridge lines of plural split cores formed of the continuous windings are formed so that the cores are not shifted in the axial direction. It is preferable to enable mounting from the axial direction and to improve easiness of assembling the split cores into a ring by forming either the recesses or the projections in the fitting section with the other phase.

According to the present invention, in the core of the motor formed of the split cores formed of the plural teeth, the plural uneven sections are arranged in the axial direction on the contacting surfaces of the teeth of a same phase to be connected in the continuous winding, the cores are prevented from being shifted from each other in the axial direction by a strutting force caused by the bridge line of the winding, and thereby deterioration of the characteristics such as the cogging torque and the torque ripple caused by shifting between the teeth can be improved. Also, when either the recesses or the projections only are formed in the contacting section between the teeth of different phases, workability of assembling the split cores formed of the plural teeth into a ring can be improved.

### BRIEF DESCRIPTION OF THE DRAWINGS

FIG. 1 is a perspective view showing an overall configuration of an electric power steering motor of a mechanically and electrically integrated structure;

FIG. 2 is a perspective view showing the appearance of a motor section;

FIG. 3 is a cross-sectional view showing a cross section of the motor section;

FIG. 4 is a perspective view when split cores are assembled into a cylindrical shape;

FIG. 5A is a top view of a layout pattern of a core formed of the split cores;

FIG. 5B is a rear view of a layout pattern of a core formed of the split cores;

FIG. 6A is a plan view showing a shape of one sheet of a core of the split cores;

FIG. 6B is a plan view showing a shape of one sheet of a core of the split cores;

FIG. 6C is a plan view showing a shape of one sheet of a core of the split cores;

FIG. 7 is a drawing of a sub-assembly of split cores for two continuous winding;

FIG. 8 is a perspective view of a minimum unit of a core when a winding is wound by two continuous winding;

FIG. 9 is a top view when the split cores are assembled (coils are not shown);

FIG. 10 is a top view explaining the shape of a tooth;

FIG. 11 is a configuration drawing of a core of the second embodiment;

FIG. 12 is an explanatory drawing when unit cores are connected and fixed by an adhesive tape;

FIG. 13 is an explanatory drawing explaining the winding work of connected cores fixed by the adhesive tape;

FIG. 14 is a drawing explaining a folded section of abridge line straddling over the split cores; and

FIG. 15 is a drawing explaining the folded section of the bridge line straddling over the split cores.

### DETAILED DESCRIPTION

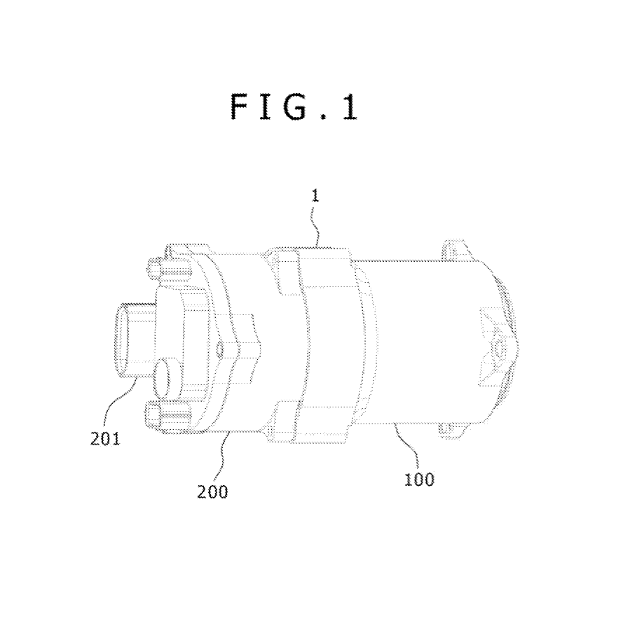

Below, embodiments will be described using FIG. 1 to FIG. 13.

### First Embodiment

In the present embodiment, a mechanically and electrically integrated type electric power steering (abbreviated as EPS) motor structure will be described in which a motor and a control unit of the electric power steering motor are formed of an integrated structure.

FIG. 1 is an example of an aspect explaining a structure of an electric power steering motor of the present embodiment. A mechanically and electrically integrated EPS motor 1 is formed of a motor unit 100 and a control unit 200. In the control unit 200, a connector 201 is arranged to which the power is supplied. In the control unit 200, an inverter and a control board for driving the motor are furnished. The motor unit 100 is configured so that three-phase drive power is supplied from the control unit 200. To the right of the motor unit 100, an output shaft capable of outputting torque of the motor is arranged although it is not illustrated.

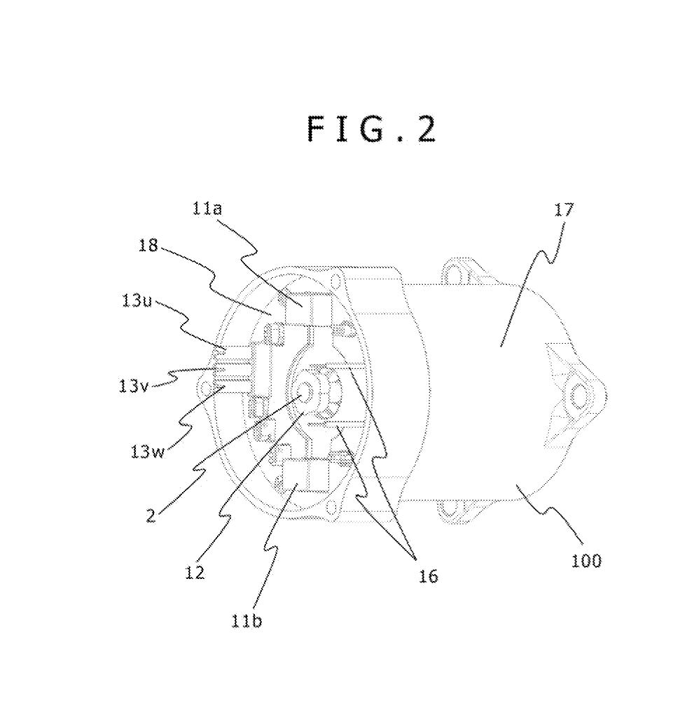

The structure of the motor unit 100 will be described in detail using FIG. 2. FIG. 2 shows a structure in which the control unit 200 of FIG. 1 described above has been removed. The motor unit 100 is formed of a stator, a rotor, and coils (not illustrated) for forming a motor inside an aluminum housing 17. Electric connecting points to the control unit 200 are a U-phase terminal 13u, a V-phase terminal 13v, a W-phase terminal 13w connected to the three-phase winding, and power source terminals 16 for driving relays. A terminal board 18 is configured to be molded by a resin, and two pieces total of a relay 11a and a relay 11b are furnished on the resin board. Also, a resolver rotor 12 for detecting the magnetic pole is pressed in to a motor shaft 2 in the center part of the terminal board 18.

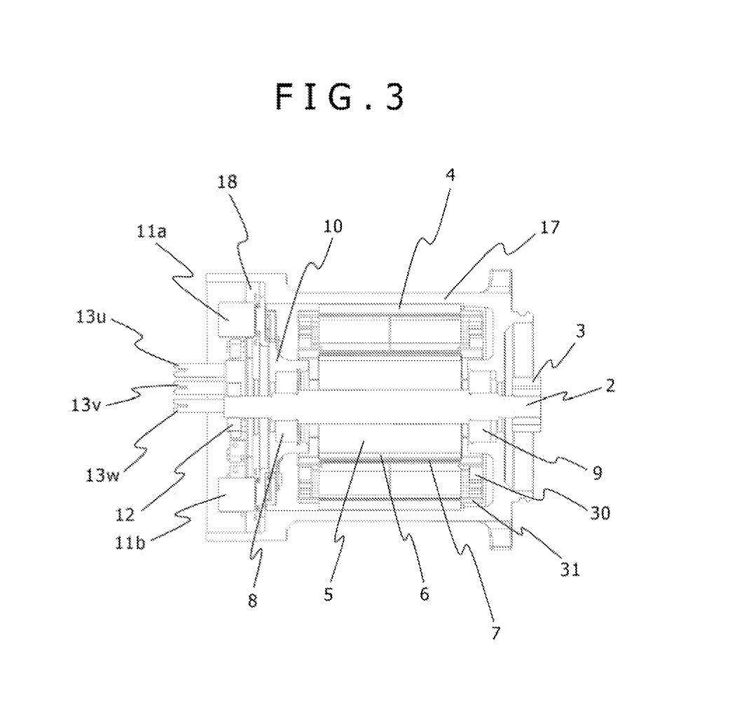

The cross-sectional structure of the motor unit 100 will be described using FIG. 3. To the aluminum housing 17, a stator core 4 is fixed by shrinkage fitting. In the stator core 4, coils 30 are wound around resin bobbins 31. In the inner peripheral section of the stator core 4, a rotor core 5 is arranged on the basis of the shaft 2, a magnet 6 is disposed in the outer peripheral section of the rotor core 5, and a magnet cover 7 is arranged in the outer peripheral section of the magnet 6. The magnet cover 7 is formed of a material of a non-magnetic body. With respect to bearings of the shaft 2, an F bearing 9 disposed on the output shaft side is held by the aluminum housing 17. Also, a gear 3 for power transmission is arranged at the distal end of the output shaft. With respect to the bearing opposite to the output side, an R bearing 8 is arranged, and an outer ring of the R bearing 8 is held by a bearing cover 10. The bearing cover 10 is screw (not illustrated) -fixed to the aluminum housing 17 using screw holes same to those for the terminal board 18. On the terminal board 18, as described above also, the three-phase terminals which are the U-phase terminal 13u-the W-phase terminal 13w for electrically connecting to the control unit 200 are arranged. Also, the relay 11a and the relay 11b for switching electric connection of the three-phase winding and relay power source terminals for controlling these relays are arranged.

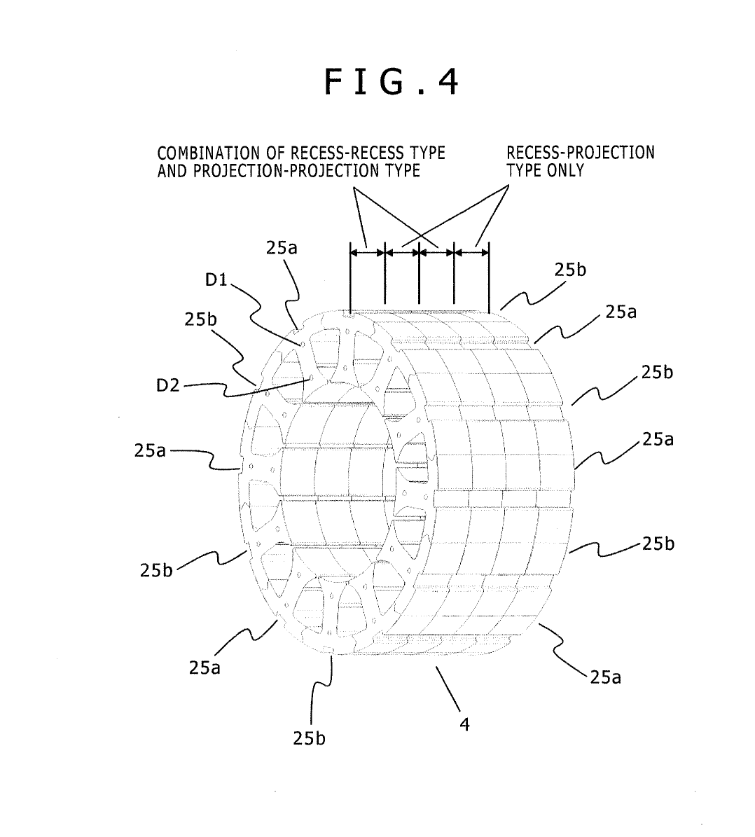

In the configuration above, the stator core 4 will be described in detail. FIG. 4 shows an overall structure of the stator core 4. The stator core 4 of the present embodiment is formed of split cores. Also, in the stator core 4, two kinds of core sub-assemblies 25a and 25b are alternately arrayed, and the stator core 4 is formed of the sub-assemblies of 12 pieces in total. In the motor of the present embodiment, the coils are formed by concentrated winding, and the slot combinations are 10 poles-12 slots, 14 poles-12 slots, 16 poles-18 slots, 20 poles-18 slots, 14 poles-15 slots, 16 poles-15 slots, and 8 poles-9 slots. In these slot combinations, the coils are combined so that the coils of a same phase are disposed adjacently to each other. For example, the 10 poles-12 slots is configured that two U-phase coils are arrayed continuously and the winding directions thereof are directed oppositely to each other.

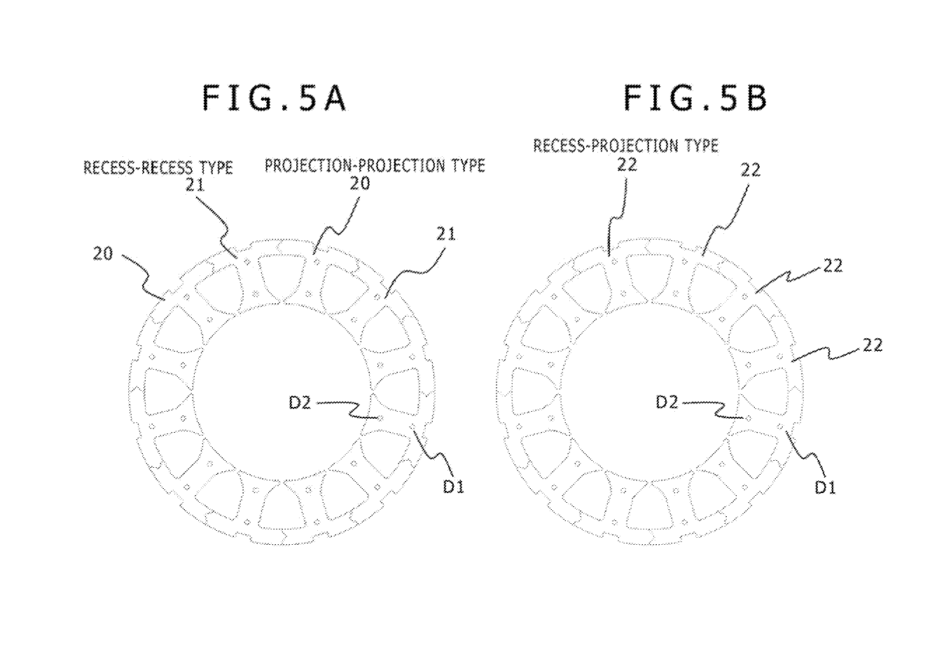

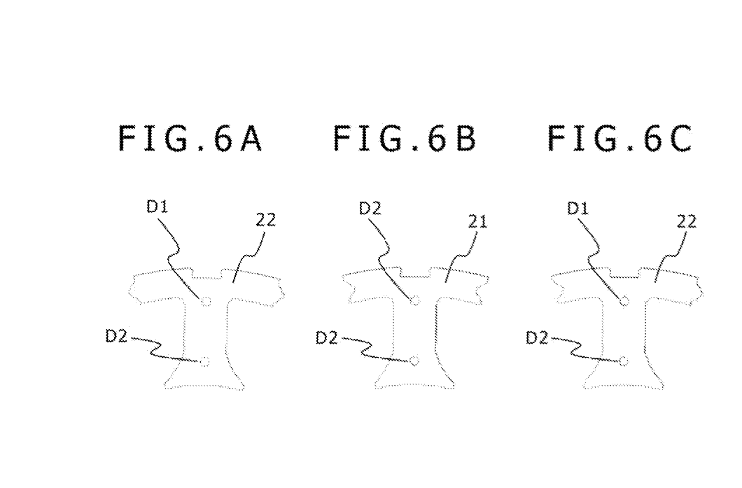

The state of it is shown in FIG. 5A and FIG. 5B. FIG. 5A shows one in which projection-projection type cores 20 and recess-recess type cores 21 of the core back contact surfaces are arrayed alternately into a ring shape. With respect to tightening of the cores in the axial direction, the cores are fixed to each other by two of an outside diameter side dowel section D1 and an inside diameter side dowel section D2. FIG. 5B shows one in which recess-projection type cores 22 are arrayed continuously into a ring shape. Similarly to the case of FIG. 5A, fastening in the axial direction is executed by the dowel sections D1 and D2. FIG. 6A to FIG. 6C show the shapes of the respective teeth. FIG. 6A shows the projection-projection type tooth 20, and projections are arranged on both surfaces of the core back which fit to the adjacent teeth. In the recess-recess type tooth 21 shown in FIG. 6B, the shape of the fitting surface is of a recess-recess type. FIG. 6C shows the recess-projection type tooth 22, and has a feature that the fitting surface on one side is of a recess type and the shape of the other is of a projection type.

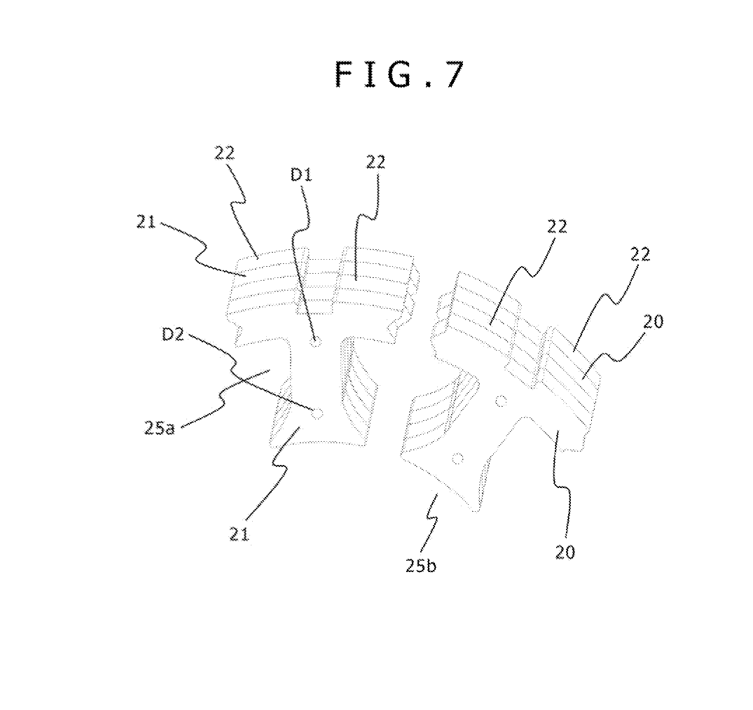

FIG. 7 shows a structure of stacking four stages in which plural sheets of the recess-recess type teeth 21 described above are stacked in the axial direction, thereafter the recess-projection type teeth 22 are stacked, the recess-recess type teeth 21 are stacked then, and the recess-projection type teeth 22 are stacked further. This one set of teeth is shown as the core sub-assembly 25a. On the other hand, the core sub-assembly 25b shows one in which plural sheets of the projection-projection type teeth 20 is stacked in the front, then the recess-projection type teeth 22, the projection-projection type teeth 20, and the recess-projection type teeth 22 are stacked in this order. It is configured that the contact sections of the two cores can be alternately fitted to each other by equalizing the stacking sheet number of each. As a result, the end surfaces of the cores can be made agree to each other in the axial direction. Also, in the fitting sections on the left side surfaces of the core sub-assembly 25a out of these core sub-assemblies, the recesses are configured to be formed continuously in the axial direction. Further, the fitting sections on the right side of the core sub-assembly 25b include the projections that continue in the axial direction. With this configuration, the core sub-assembly 25a and the core sub-assembly 25b fit to each other without being shifted from each other in the axial direction; however, the core sub-assembly 25a and the other adjacent core sub-assembly 25b are configured to be capable of relatively sliding to each other in the axial direction.

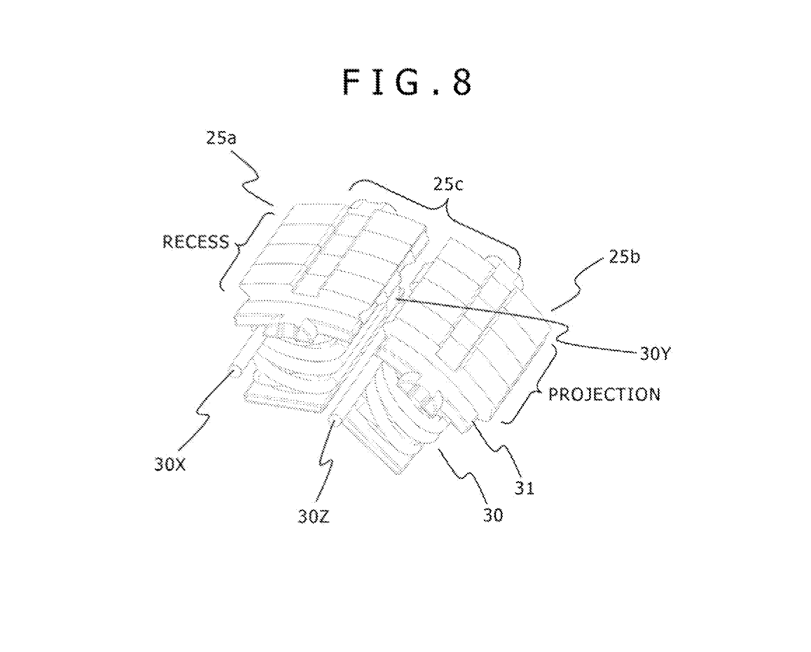

FIG. 8 shows a winding structure formed by two continuous winding. In this drawing, a winding employed in 10 poles-12 slots and 14 poles-12 slots is shown. The core sub-assemblies are same to those shown in FIG. 7. Bobbins 31 are attached to the core sub-assemblies 25a and 25b shown in FIG. 7, and the coils 30 are wound around the bobbins 31. A lead wire 30X is the start of the winding, and a lead wire 30Z is the end of the winding. These two windings are connected by a bridge line 30Y. Because the lead wire 30Z has a portion crossing the bridge line 30Y that is arranged between the cores, it is preferable that the lead wire 30Z passes through an insulation tube. The windings are formed of one continuous wire. When there is no uneven section on the contact surfaces of the two cores and the length of the bridge line disperses, the core sub-assemblies shift from each other in the axial direction, and therefore the cogging torque characteristic of the motor deteriorates. However, according to the present invention, the bridge line is set slightly long, a folded section is arranged in the electric wire in the middle of the bridge line 30Y, the core sub-assemblies are positioned in the axial direction by the fitting section of the uneven shape, thereby the shift amount of the cores can be reduced, and the amount of the cogging torque can be reduced. It is featured that the excess length of the coil is configured to be capable of being adjusted by the folded section arranged in the bridge line 30Y described above by correcting the shift amount of the core.

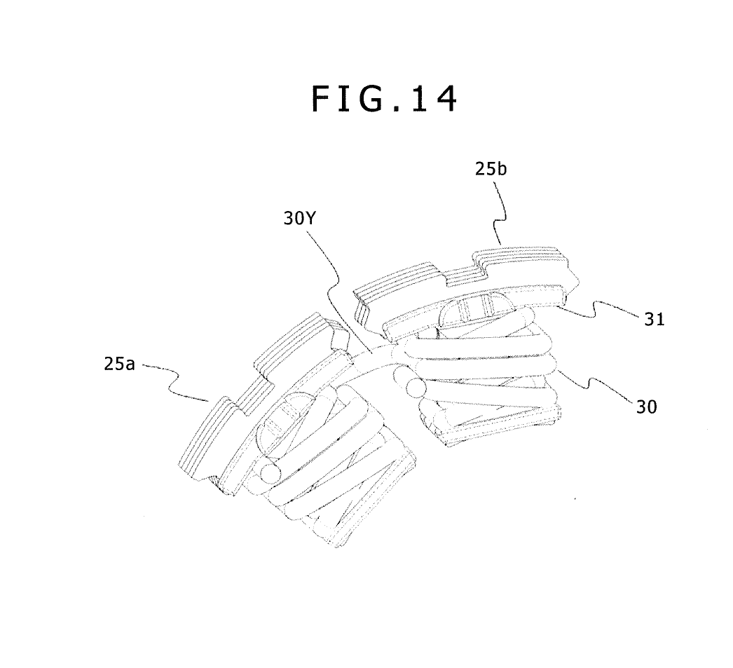

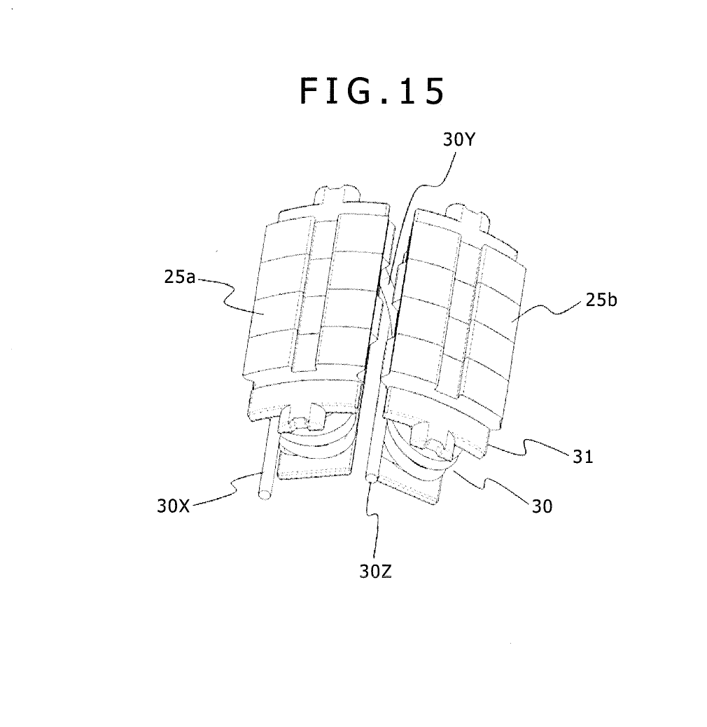

FIG. 14 and FIG. 15 are drawings explaining the folded section. The bridge line 30Y is configured to include the folded section where the middle of the bridge line is bent. More specifically, the folded section is formed by shaping the electric wire into a curved or dog leg shape within the shaft end surface of the coil (slot section) . That is, the electric wire is bent so as to have an allowance in the slot section so that the electric wire is not straight but becomes longer than the straight line.

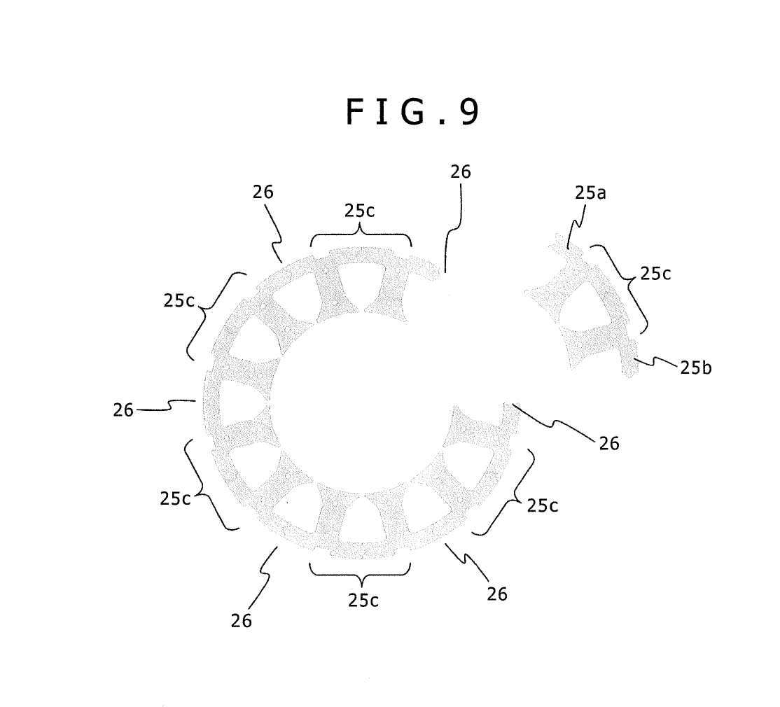

FIG. 9 shows a state one phase core sub-assembly 25c is assembled along respective slide insertion sections 26 from the top in assembling the last one set when the one phase core sub-assemblies 25c described above are to be assembled (in this explanatory drawing, the bobbins and the coils are not shown). When the step in the axial direction is not arranged over the entire periphery of the core sub-assemblies, assembling from the axial direction becomes possible. Also, when the steps in the axial direction are in two steps, assembling is possible, and alignment of the respective core sub-assemblies end surfaces is also possible.

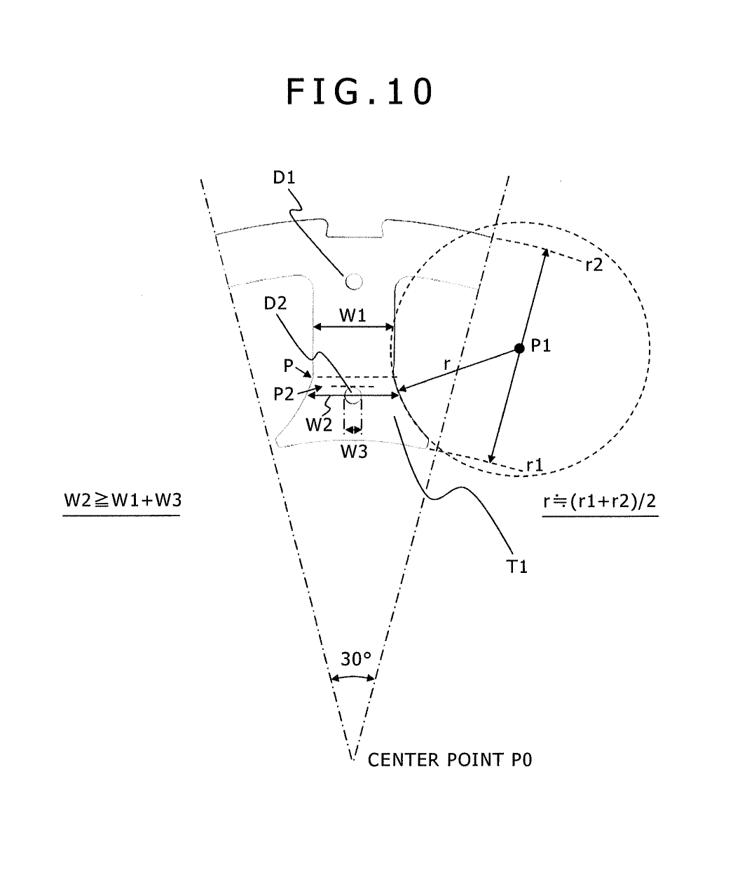

The core shape will be described referring to FIG. 10. Because the motor for the present description is of 10 poles-12 slots type, it is formed of 12 teeth. Therefore, one tooth is configured to have the opening angle of formed of 30 degrees in terms of the mechanical angle with the reference of the center point P0. The outside diameter of the stator is approximately 85 mmΦ, and the inside diameter side is approximately 49 mmΦ. Tooth width W1 is approximately 6.0 mm, the diameter of the dowel fastening section on the inside diameter side is 1.5 mm, and the tooth width W2 of the dowel tightening center section is configured to be wider than the tooth width W1 as illustrated. That is, because a dowel tightening section D2 involves magnetic deterioration, the tooth width W2 of the dowel tightening section is made W2≧W1+W3. In order to achieve this structure, it is necessary that the dowel tightening section D2 is disposed on the inside diameter side of a tooth inside diameter side expanding section P point, and that the total of a dowel tightening section width W3 and the tooth width W1 is equal to W2 at least. On the other hand, with respect to the disposal position of the dowel tightening section, when the point on the outermost outside diameter side of the dowel tightening section is P2, P2 exists on the inside diameter side of the tooth inside diameter side expanding section P. As described above also, the dowel tightening section is subjected to perforation strain, the magnetic characteristic deteriorates, and therefore it is preferable that the dowel tightening section is not positioned close to the inner periphery side of the stator. The reason is that, when the dowel tightening section is arranged on the inside diameter side, a magnetically deteriorated section is generated on the inner peripheral surface of the tooth, and a problem that the cogging torque increases occurs. Although the above description explained on the effect on the cogging torque, as an actual motor, reduction of the torque ripple is also important. Particularly, when the use is for electric power steering, the requirement value is severe, and the upper limit of the torque ripple required for electric power steering is approximately 2% in general. In order to satisfy this value, it is important to employ a magnetic circuit configuration that does not generate local magnetic saturation in the tooth at the maximum amperage. In the case of the present structure, the position liable to generate the local magnetic saturation is the position of T1 shown on the inner periphery side of the tooth. In order to secure a magnetic flux passing area of the tooth distal end section, such a shape that the expansion section of the tooth inner periphery section gradually expands is effective. In the present invention, the shape of the tooth inner periphery side expansion section was made an arc shape, and the radius of the arc was increased to approximately 12 mm to the degree the arc could be approximated generally to a straight line. As a result, the center point P1 of the arc radius was outside of 30 degrees that was the opening angle of one tooth, the center point P1 of the arc radius was disposed generally at the center between the stator outermost periphery radius and the stator inner periphery radius, and thereby the both characteristics of the cogging torque and the torque ripple described above resulted to be satisfied in the best condition.

### Second Embodiment

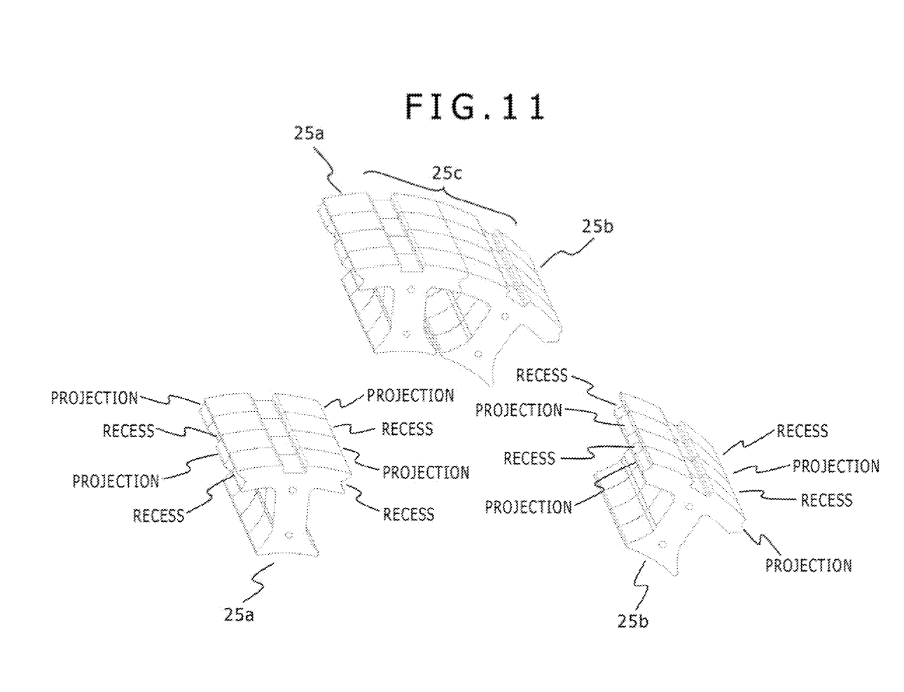

FIG. 11 is an explanatory drawing of a core structure showing the second embodiment of the present invention. The core sub-assembly 25a is obtained by stacking plural sheets of the teeth whose core back section is formed into the recess-recess shape on both sides in the axial direction, and stacking those of the projection-projection shape, those of the recess-recess shape and those of the projection-projection shape in this order. The core sub-assembly 25b is opposite thereof, and starts with the projection-projection shape followed by the recess-recess shape, the projection-projection shape, and the recess-recess shape in this order. These two kinds of the core sub-assemblies 25a and 25b are connected with each other to form the core sub-assembly 25c for one phase. Although illustration of the coil and the bobbin is omitted in the drawing, the bobbin is attached actually, and the coil is wound around the outer peripheral section thereof by concentrated winding. In the present embodiment, because the drawing of 10 poles-12 slots is shown, when the winding direction of the coil of the core sub-assembly 25a is clockwise, the winding direction of the coil of the core sub-assembly 25b should be opposite which is counterclockwise. When windings are wound for two core sub-assemblies continuously by one wire, the bridge line straddling the sub-assemblies is required. When the bridge line is thick, shifting of the cores cannot be corrected. Therefore, as described above, the folded section was arranged in the electric wire in the middle of the bridge wire so that the sag in the electric wire could be adjusted by the folded section. In the present invention, in the winding of those in which the teeth adjacent to each other are formed of a same phase such as 10 poles-12 slots, 14 poles-12 slots, and the like and of the case the coils wound around the teeth adjacent to each other are desired to be connected in series, by restricting the shifting amount of the teeth by the bridge line that straddles over the respective teeth in the axial direction by the uneven shapes described above, magnetic shifting is to be eliminated, and such generation of the cogging torque and generation of the torque ripple as described above is to be suppressed. Also, according to this second embodiment, because the right and left shapes of the teeth are always same, when the entire core is pressed in to the housing, the press-in directions of the cores against the pressing force are directed in a co-axial direction. Accordingly, because generation of torsion of the cores can be suppressed, generation of the cogging torque and generation of the torque ripple described above can be suppressed.

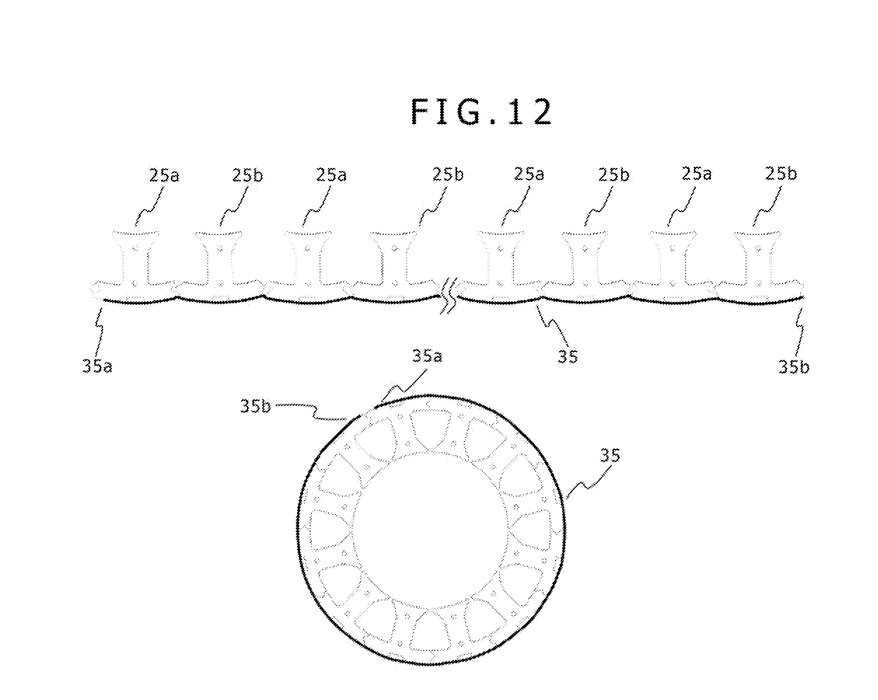

FIG. 12 explains a method in winding with respect to the cores described above. In a state of a core single body formed integrally into a cylindrical shape, a tape 35 having an adhesive layer on the inner peripheral surface is adhered to the core outer peripheral section so as to maintain the cylindrical shape. The tape is adhered so that the position of the start of the winding comes to the position apart at an interval from the end of a core as shown by 35a. Also, the end of the winding is made the position shown by 35b as illustrated. In this state, the adhesive tape 35 becomes connecting sections of the split cores, and can achieve a motion same to that of joints between the cores. A state all of the core sub-assemblies 25a and 25b are linearly spread is shown.

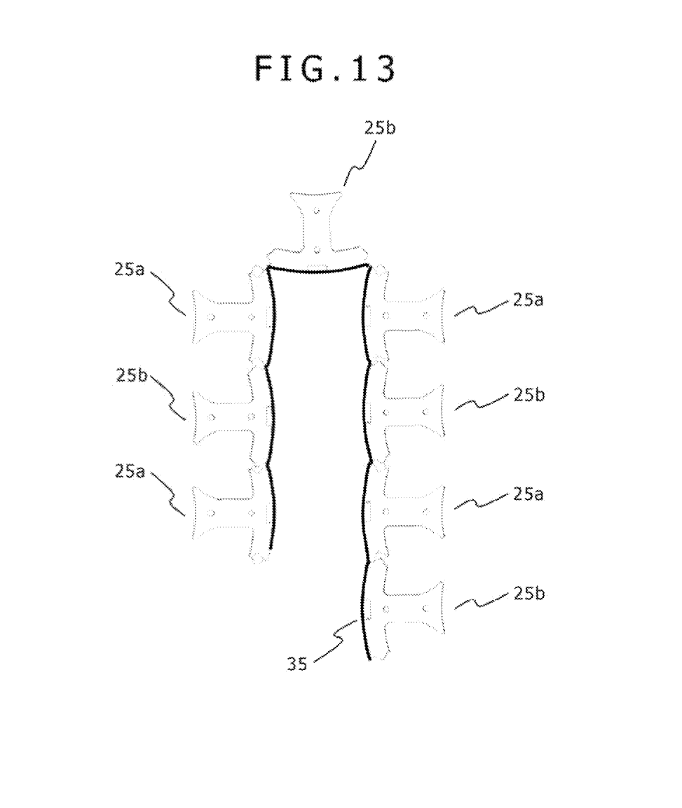

FIG. 13 shows a shape of the entire core in actual winding work. A bobbin is inserted and winding is subjected to the tooth to be subjected to winding, and the tooth is transferred to the left side in the drawing when winding is finished. In this drawing, the bobbins and the coils on the left side where winding is finished are omitted. Also, with respect to winding, a nozzle winding method using a nozzle is suitable. When winding using the adhesive tape 25 described above is finished, the entire periphery is rounded again, and shrinkage fitting to the housing is performed. Because an adhesive tape layer wound generally uniformly around the outer peripheral section of the stator core is uniformly arranged on the inner peripheral surface of the housing, the roundness of the inner periphery of the stator relative to the rotor of the motor can be improved. Thus, the cogging torque and the torque ripple of the motor can be suppressed. Also, because the tape acts as a constant shock absorbing material between the stator core and the housing, such an effect of hardly transferring the magnetic vibration of the stator core to the housing can be secured, and therefore the noise of the motor can be reduced. Accordingly, connection of the joints by the adhesive tape not only can improve easiness of winding but also can reduce the cogging torque and the torque ripple by improvement of the roundness and can reduce the magnetic sound.

What is claimed is:

1. An electric actuator having a motor, a plurality of teeth including a continuous winding being formed into a stator core of a ring shape, one wire being continuously wound around the teeth adjacent to each other in the continuous winding,
wherein the stator core is configured that step sections of an uneven shape in the axial direction are arranged in butting sections between the teeth connected by the continuous winding, and the uneven shapes are fitted to each other.

2. The electric actuator according to claim 1, formed of 10 poles-12 slots, 14 poles-12 slots and integer multiples thereof, wherein one wire is continuously wound around two teeth.

3. The electric actuator according to claim 1, formed of 16 poles-18 slots, 20 poles-18 slots and integer multiples thereof, wherein one wire is continuously wound around three teeth.

4. The electric actuator according to claim 1, formed of 14 poles-15 slots, 16 poles-15 slots and integer multiples thereof, wherein one wire is continuously wound around five teeth.

5. The electric actuator according to claim 1, wherein the stator core is configured that step sections of an unevenness shape are arranged alternately in the axial direction in butting sections of teeth over which a bridge line for same phase windings straddles, either a recess shape or a projection shape is formed uniformly in the axial direction in butting sections of teeth of different phase, and the butting sections are fitted to each other.

6. An electric actuator in which in a stator core thereof formed of split cores and having a winding structure in which one continuous wire is continuously wound around all teeth, core back contact surfaces formed into a projection shape and core back contact surfaces formed into a recess shape are disposed alternately in the axial direction on the contact surfaces between teeth over which a bridge line of coils straddles.

7. The electric actuator according to claim 6, wherein relation between a stator and a rotor is a combination of integer multiples of 6 poles-9 slots, and three-phase windings are connected by A wire connection.

8. The electric actuator according to claim 1, wherein dowel tightening sections that fasten teeth in the axial direction are arranged in two positions in the tooth, the dowel tightening section disposed on the inner periphery side of the tooth is arranged on the inside diameter side of a minimum width section of the tooth, the tooth has a generally arc shape expanding to the inside diameter side from the minimum width section of the tooth, and the center of the arc is positioned outside the opening angle of a split core.

9. The electric actuator according to claim 1, wherein split cores are assembled in a state not welded to each other when the split cores are assembled into a ring shape and are inserted into a housing.

10. The electric actuator according to claim 1, wherein the stator core is formed of the teeth having shapes of three kinds.

11. An electric actuator formed of split cores formed by concentrated winding, wherein one core sub-assembly is configured that a recess-recess type tooth and a projection-projection type tooth are arrayed alternately in the axial direction, a core sub-assembly adjacent thereto is configured similarly by a recess-recess type tooth and a projection-projection type tooth, and arraying order is opposite to each other so that contacting surfaces of two cores agree to each other.

12. The electric actuator according to claim 1, wherein an adhesive tape is arranged on the outer peripheral surface of the stator core, and the stator core is assembled to a housing by shrinkage fitting.

13. The electric actuator according to claim 1, wherein a folded section is arranged in abridge line that is arranged between teeth adjacent to each other around which one wire is wound continuously.
